(19) United States
(12) Patent Application Publication
(10) Pub. No.: US 2008/0137922 A1
(43) Pub. Date: Jun. 12, 2008

(54) Organization of dissimilar data for platform-independent diagnostic imaging presentation

(75) Inventors: Leo R. Catallo, Mercer Island, WA (US); Jonathan P. Hendrich, Seattle, WA (US); David D. Deer, Bothell, WA (US)

Correspondence Address: FULBRIGHT & JAWORSKI L.L.P, 2200 ROSS AVENUE, SUITE 2800, DALLAS, TX, 75201-2784, US

(73) Assignee: SonoSite, Inc., Bothell, WA (US)

(21) Appl. No.: 11/637,485

(22) Filed: Dec. 12, 2006

(51) Int. Cl. G06K 9/20

(52) U.S. Cl. 382/128

(57) ABSTRACT

Methods and systems for converting dissimilar raw data collected primarily from one or more imaging devices into standard formats, organizing the formatted data into a hierarchical arrangement to facilitate efficient memory storage and subsequent retrieval, generating an imaging presentation, and recording that presentation onto portable media are shown. The imaging presentation can be subsequently viewed by a user by accessing the portable media using a platform-independent interface.

### CROSS-REFERENCE TO RELATED APPLICATIONS

This application is related to concurrently filed, co-pending, and commonly assigned U.S. patent application Ser. No. 065744-P033US-10610771 entitled “MEDIA RICH IMAGING REPORT GENERATION AND PRESENTATION,” the disclosure of which application is hereby incorporated herein by reference.

### TECHNICAL FIELD

The present invention relates generally to the processing of data by an imaging device and more particularly to the processing of data by an imaging device to provide a hierarchical arrangement of data on portable media.

### BACKGROUND OF THE INVENTION

An imaging device is any device that acquires information and transforms the information into a form suitable for visual perception and/or electronic use, such as an imaging modality unit that may include related peripheral equipment. An imaging modality unit is a medical system that is used to display an image that accurately represents anatomy. Prevalent imaging modalities used today include ultrasound, X-ray, computer tomography (CT), magnetic resonance imaging (MRI), endoscopic ultrasonography, nuclear medicine imaging, and video endoscopy. Imaging modality units, which may include related peripheral equipment, generally capture or otherwise contain images and patient information that corresponds to a procedure performed for diagnostic purposes. That information is maintained at least temporarily in the imaging device. The information is temporary in the sense that the limited memory component of many imaging devices requires that the information be erased or downloaded prior to the performance of new procedures by the imaging device operator. Otherwise, the information captured by the imaging device may be overwritten as a new procedure is performed. Often the medical practitioner saves the information to a long-term repository or archival storage, which may be a hospital network and its database servers. In the case of a small medical practice, a personal computer or a network of personal computers may be used.

Standards relating to the formatting of imaging modality data and its subsequent storage are limited. The Digital Imaging and Communications in Medicine (DICOM®) standard was created by the National Electrical Manufacturers Association to aid the distribution and viewing of medical images, such as CT scans, MRIs, and ultrasound. DICOM is used as a protocol to converse with various imaging devices, archival systems, and reporting systems. Because DICOM is generally implemented in complex diagnostic environments, such as large hospitals, the systems that utilize this standard tend to be very expensive. As a result, individual modality vendors will often provide an off-platform solution in order to assist individual medical practitioners, medical groups, or small hospitals in the storage and retrieval of information.

Because DICOM is merely a standard, it is incumbent on individual device manufacturers to ensure that their products are fully DICOM-compliant and are capable of communicating with other supposedly DICOM-compliant devices. Device manufacturers that use the DICOM standard are obligated to publish a conforming statement of all the DICOM-compliant components within a particular device.

Even where the DICOM standard is implemented, images that are not DICOM-compliant may be embedded within a DICOM-compliant file, which may prevent the user from viewing the non-DICOM-compliant image within the DICOM platform. Applications that enable viewing of non-DICOM-compliant image formats are limited in that the image format is unavailable for viewing simultaneously with the DICOM-compliant images.

With respect to ultrasound technology, DICOM addresses the extraction of information from the ultrasound machine and its storage onto an archival server. Unfortunately, the implementation of the DICOM ultrasound application can be cost prohibitive for small medical practices due to the significant costs associated with acquiring, implementing, administering, and maintaining the DICOM computing environment. Because the DICOM standard is limited to facilitating communication between imaging devices and archival devices, the DICOM standard does not provide a user with the ability to easily retrieve the archived information or subsequently utilize that information in any meaningful way. And although the DICOM standard is a fixture in large hospital enterprises, its use in small medical practices is practically nonexistent.

Data that is captured by an imaging modality can be stored in the memory of the imaging modality unit, stored/saved on a personal computer or server, or stored/saved onto portable media. Data derived from an imaging modality that is not stored using a DICOM-compliant format is typically stored using a proprietary format. Therefore, in order for the information to be subsequently utilized in any meaningful way, the development, deployment, and use of custom software applications is usually required. It is generally the medical practitioner's responsibility to maintain and manage the information even if a proprietary format is used.

Once raw data is acquired by the imaging modality and exported to an archive or portable media, the organization of that data becomes problematic. Generally, medical practices will not only save the imaging modality data in a proprietary format, but will do so using a haphazard approach to the organization of this data within the archival system. The organization of the files will often be chronological and no effort is made to facilitate subsequent location and extraction of the files from the archival system.

Because custom applications are normally required to efficiently retrieve and utilize the imaging modality data, the costs associated with software development, deployment, and maintenance of these systems can be substantial. Complications further arise when software operates on the imaging modality unit or a personal computer, but not on both. Proprietary applications are needed whenever the data sought to be retrieved uses a proprietary format or is inadequately organized for subsequent retrieval. This is especially true when the data at issue is contained in a variety of forms (e.g., image, video, text) and often multiple proprietary software applications are needed to access, view, and/or print all of the relevant data. For example, one application may be used to display and print an ultrasound image while a separate application may be needed to review a text-based ultrasound report.

### BRIEF SUMMARY OF THE INVENTION

The present invention is directed to systems and methods in which piecemeal raw data relating to diagnostic imaging are formatted and hierarchically organized so that an imaging presentation derived from the data can be exported onto portable media, which can be accessed using a platform-independent interface that supports a variety of standard formats. Diagnostic imaging is usually effected by an imaging device, which in a preferred embodiment of the invention is a medical diagnostic device such as an imaging modality unit.

An embodiment of the invention is capable of receiving raw data from a variety of sources and formatting the raw data so that the imaging presentation contained on the portable media is readable without proprietary software. When all of the data at issue is appropriately formatted, the invention organizes the data hierarchically so that data can be easily located and retrieved. The hierarchical organization within the system further facilitates the exportation of the diagnostic imaging content because the same organization may be used to generate the imaging presentation.

Because the imaging presentation contained on the portable media can be accessed using a platform-independent interface, a user wanting to access the information does not need proprietary software to view the imaging presentation. One embodiment of a platform-independent interface that supports a variety of standard formats may be a standard web browser and any plug-ins that allow the user to view computer files that are written in non-proprietary or open source formats. For example, one embodiment of the invention can be used in any computing environment equipped with a web browser, regardless of the computing platform (e.g., PC, Macintosh®, Unix®).

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a functional block diagram of an embodiment of the invention;

FIG. 2 illustratively represents the screen display of an exemplary presentation frame of a start page;

FIG. 3 illustratively represents the screen display of an exemplary presentation frame of an report page;

FIG. 4 illustratively represents the screen display of an exemplary presentation frame of an ultrasound video;

FIG. 5 illustratively represents the screen display of an exemplary frame of an ultrasound still image;

FIG. 6 illustratively represents the screen display of an exemplary presentation frame of a patient's cardiac report;

FIG. 7 is a flow chart demonstrating an embodiment of the process for processing imaging data in accordance with the present invention; and

FIG. 8 illustratively represents an imaging system adapted according to embodiments of the present invention.

### DETAILED DESCRIPTION OF THE INVENTION

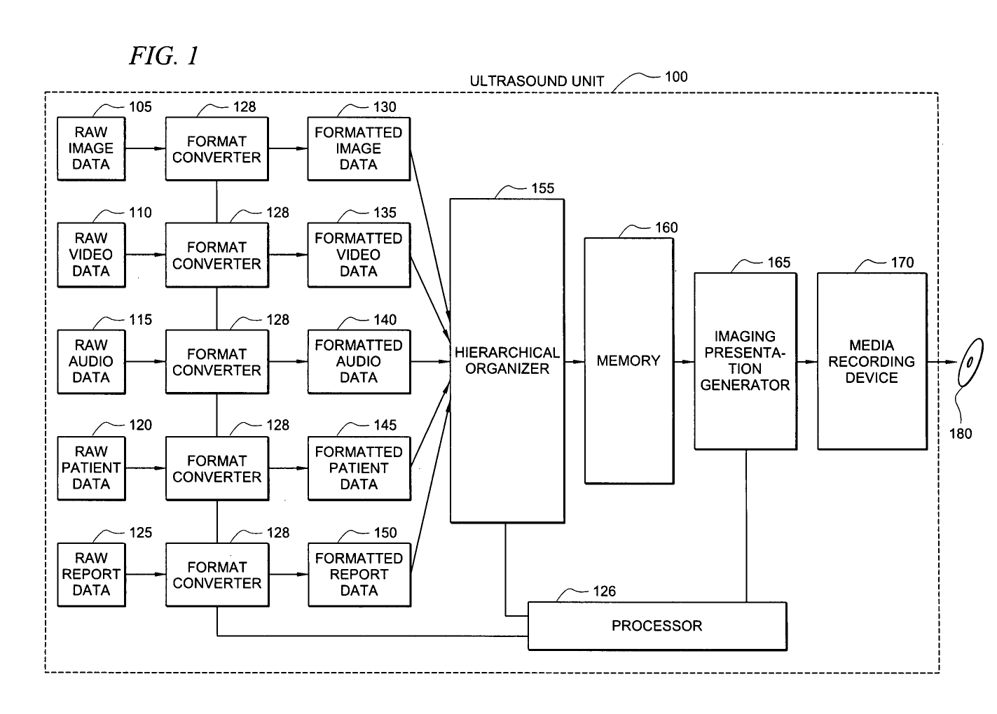

FIG. 1 is a functional block diagram of an embodiment of the invention showing a system for processing the raw data by ultrasound unit 100, converting the raw data into one or more standard formats, organizing the data into a hierarchical arrangement, creating a imaging presentation, and recording the presentation onto portable media 180. The specification will generally use ultrasound as an example of an imaging device that can generate a wide variety of relevant data types (e.g., audio, video, text). For example, with respect to an ultrasound procedure performed to monitor a developing fetus, the movement of the fetus (video) and its heartbeat (audio) may be of interest to both the patient and the treating physician.

After the various forms of raw data are converted into standard formatted data that can be used effectively, the newly-formatted data is organized and stored in memory 160 of ultrasound unit 100 using a hierarchical arrangement. The hierarchical arrangement of these embodiments is basically an inverted tree-like structure in which individual files are grouped into multiple levels and/or categories of data. Once all of the relevant data has been collected, sufficiently formatted (if necessary), and stored in memory 160 using the invention's hierarchical format, the processor of ultrasound unit 100 can then generate an imaging presentation that utilizes some or all of the formatted data that is related to a particular patient or imaging procedure. Although ultrasound unit 100 will likely be displaying certain images derived from the ultrasound procedures on a monitor of some kind while the procedure is being performed, the invention is generally directed to the archiving of such images for subsequent, off-line analysis. After the presentation has been generated using the formatted data, the presentation can then be recorded onto portable media 180. The presentation contained on portable media 180 can be accessed using a platform-independent interface, which means that no proprietary software or particular computing environment is needed to view the presentation. Processor 126 performs many of the functions of the invention as determined by the code that defines the processor's functions within the system, including functions of format converters 128, hierarchical organizer 155, and imaging presentation generator 165.

An ultrasound exam may produce, for example, five general categories of raw data that are processed by the present invention: raw image data, raw patient data, raw report data, raw video data, and raw audio data. Each of these types of data may be dissimilar because the nature of the data may require these types of data to be stored in different formats (e.g., an image may be embodied in a JPEG file while an audio clip may be embodied in a WAV file). Even raw patient data and raw report data, both of which are primarily textual in nature, may be recorded in dissimilar formats. Any imaging modality used for diagnostic purposes may capture at least some data associated with these general categories.

Raw data is information that is input into the imaging device, received by the imaging device, or recorded by the imaging device using a proprietary or non-standard format. Standard formats include any open source formats or widely supported formats such as JPEG, MPEG, WAV, XML, HTML, and XHTML. For example, an ultrasound device may record video of the ultrasound procedure in a format that is proprietary to the ultrasound device manufacturer. Because this video data is recorded by the imaging device in a proprietary format, which remains unprocessed according to the present invention, it is referred to herein as raw video data. Once the raw data has been formatted according to the present invention so that it no longer uses a proprietary or non-standard format, the raw data becomes formatted data. Similarly, if information is input into the imaging device, received by the imaging device, or recorded by the imaging device in a non-proprietary or standard format in accordance with the present invention, the data is considered formatted data and not raw data. Because data derived from imaging devices have historically been stored in the imaging devices using proprietary formats developed by independent device manufacturers, custom software has generally been needed to view even a single category of raw data derived from one or more imaging procedures.

Raw data can include a variety of information germane to the diagnostic imaging procedure being performed. Raw image data 105 will usually be comprised of one or more images at distinct points in time. For example, a magnetic resonance image (MRI) of a patient's brain may be a single image of the patient's brain at a given point in time. Depending on the proprietary or non-standard format used, raw image data 105 will usually include descriptions of the pixels (e.g., the layout of the pixels, the number of pixels in the image, the number of bits per pixel) and measurements of the pixels (e.g., the number of pixels equated to a centimeter). A single frame of raw image data 105 in a proprietary format might be converted into formatted image data 130 by format converter 128 using code that converts the proprietary format into files such as Joint Photograph Experts Group (JPEG) files, Graphics Interchange Format (GIF) files, and/or Portable Network Graphics (PNG) files, for example, all of which are widely used image formats.

Raw video data 110 may comprise an extension of raw image data 105 by providing a series of images so that the discrete images appear to be moving video. Depending on the proprietary or non-standard format used, raw video data 110 will usually include descriptions of the pixels (e.g., the layout of the pixels, the number of pixels in the image, the number of bits per pixel), measurements of the pixels (e.g., the number of pixels equated to a centimeter), as well information relating to the ordering and the number of individual frames to be transmitted per second. Raw video data 110 can be converted into formatted video data 135 by format converter 128 using code that converts a proprietary or non-standard video format into standard formats such as Motion JPEG (M-JPEG), Windows Media Video version 9 (WMV), and/or Moving Picture Experts Group (e.g., MPEG, MPEG-2, MPEG-4) files, for example, all of which are widely supported and non-proprietary.

Raw audio data 115 can be processed by itself or can be a part of raw video data 110 that may also include sound depending on the format configuration. Raw audio data 115 may include audio files that embody audio data derived from ultrasound unit 100 during an imaging procedure. Raw audio data 115 can be converted into formatted audio data 140 by format converter 128 using code that converts a proprietary or non-standard audio format into a standard format such as Waveform Audio (WAV) format, which is a Microsoft® and IBM® audio file format, MPEG-1 Layer III (MP3), and/or Windows Media Audio (WMA), for example, all of which widely supported audio file formats.

Raw patient data 120 and raw report data 125 are generally comprised of textual and/or numeric data. Raw patient data 120 usually relates to a patient that undergoes one or more imaging procedures and can include such information as patient name, birthday, allergies, and various identification numbers associated with the patient or the imaging procedure. Raw report data 125 usually relates to one or more imaging procedures and can include various diagnostic measurements and results as well as the time, date, and duration of an imaging procedure. Depending on the proprietary or non-standard format used, raw patient data 120 and raw report data 125 will usually include some sort of programming language with instructions relating to reading the data at issue. Text representing raw patient data 120 or raw report data 125 in a proprietary format might be converted into formatted patient data 145 or formatted report data 150 by format converters 128 using code that converts the proprietary textual format(s) of these raw data categories into a standard text-based format such as Extensible Markup Language (XML). In addition to textual formatting, an extensible language such as XML can be used to facilitate the exchange of hierarchical data, define data structures, and provide for the efficient navigation of data.

After acquiring the raw data from sources internal and/or external to the imaging device, the present invention converts the raw data into formatted data, if necessary. Because the source of the raw data processed by ultrasound unit 100 is likely to be maintained in a manufacturer-specific format and/or environment, such raw data should be converted into formatted data for further processing by the invention. However, if data is input into the imaging device, received by the imaging device, or recorded by the imaging device in a non-proprietary or standard format, the data is considered formatted data (not raw data) and can be processed directly by hierarchical organizer 155 of ultrasound unit 100.

As raw data is converted into formatted data, or as formatted data is input into the imaging device, received by the imaging device, and/or recorded by the imaging device in a non-proprietary or standard format, each of the individual data files may be assigned an identification number by format converters 128 in order to facilitate the organization of files by hierarchical organizer 155. Identification numbers can facilitate the organization and storage of formatted data by allowing the invention to determine which patient the files belong to, the type of diagnostic imaging at issue, the type of file at issue, and further identification in cases where multiple files exist sharing similar characteristics (e.g., multiple images for the same patient using the same imaging device). For example, the identification number might begin with a number that represents a particular patient (e.g., social security number), which may then be followed by a suffix that designates a type of imaging procedure (e.g., US=ultrasound), followed by a suffix that designates the type of file (e.g., IM=image), followed by a number to differentiate between similar files (e.g., 001=file number 1). In this way, the source code that implements the hierarchical arrangement feature of the invention can immediately recognize the file type and its location within the organization for immediate storage in memory 160. The above numbering convention is for exemplary purposes only and it would be apparent to one skilled in the art that any number of file naming conventions may be created and/or used to identify the range of files at issue.

The hierarchical arrangement within memory 160 of the imaging device is used to facilitate the efficient location and subsequent retrieval of the formatted data. In a hierarchical arrangement, data is preferably organized using a tree-like structure so that individual files are grouped into multiple levels and/or categories of data. In one embodiment of the invention, the formatted data is organized first by patient, then by procedure, and finally by type of data. For example, a patient may have undergone an ultrasound procedure and an X-ray procedure. The ultrasound procedure may have produced five different ultrasound images, a video image, and a report. The X-ray procedure may have produced three different images. In this embodiment, the patient occupies the top level of the hierarchical arrangement. Grouped directly beneath the patient level would be an ultrasound procedure level and an X-ray procedure level. Under the ultrasound level there could be separate levels for images, video, and reports. Under the images level of the ultrasound procedure would be the five formatted ultrasound images. Similarly, under the images level of the X-ray procedure, there would be three X-ray images for that patient.

Without the hierarchical organization of the data, the raw data would be archived in an unorganized manner similar to the storage of pictures on a digital camera that has no effective organization other than chronological even though the pictures generated are usually saved in a standard format. Unlike a digital camera that produces files in a standard format, the present invention is actually converting the raw data into standard formats, creating a logical structure for storage and retrieval, and generating a imaging presentation that enables the user to navigate through the various files using familiar displays and functions to access the content. Although there is a practical limit in terms of the memory size of the portable media, the invention can generate and use multiple standard formats if such flexibility is deemed advantageous.

The formatted data that is stored within the hierarchical arrangment of memory 160 of the imaging device can then be used to generate an imaging presentation that will allow patients, physicians, and/or other authorized third parties to view the presentation via portable media 180. The generation of the imaging presentation is performed by imaging presentation generator 165 that formats the presentation and incorporates the data into the presentation for potential recording onto portable media 180. In FIG. 1, portable media 180 is a compact disc. Other embodiments of portable media may include flash drives, floppy disks, DVDs, optical discs, or zip drives. In this embodiment, the imaging presentation will eventually be recorded onto the compact disc by recording the presentation onto the disc using media recording device 170 that performs the recording function by “burning” the presentation onto the compact disc in this embodiment. Media recording device 170 may be comprised of a disc drive with compatible recording software to facilitate the recording process.

The generation of the imaging presentation may also include converting all of the formatted textual data (e.g., formatted report data in XML) into a format such as HTML, which will display the report and patient data as ASCII text in the presentation. Although the textual data may remain in XML format, conversion of the XML textual data to HTML may be preferred due to the universal compatibility of HTML with current platform-independent interfaces, such as web browsers. Because HTML is a text file with tags that specify how content is to be formatted and displayed, HTML also contains anchor tags that can provide links to other HTML pages. This allows the user to essentially traverse different files through the hyperlinking process. The presentation may also include JPEG files, MPEG files, WAV files, XML, HyperText Markup Language (HTML), and/or Extensible HyperText Markup Language (XHTML) and is graphically tailored so that the user has a meaningful viewing experience resulting from the inherently intuitive display. Although the foregoing uses HTML as an example of the markup language that can be used to format the textual data or to specify how content is to be formatted and displayed, it is to be expressly understood that XHTML can be used for these purposes as well.

In one embodiment, the formatted data is used to create an imaging presentation designed to mimic a web page with the corresponding hierarchical levels set forth in a pane located on the left side of the display. The hierarchical levels can be accessed by actuating, or “clicking on,” the hyperlinks associated with the higher levels in the hierarchical arrangement, which will give the user access to the lower levels of data. In this embodiment, once the patient hyperlink is actuated, the procedure level and all of the procedures included at the procedure level for that patient will appear in the pane located on the left hand side of the display in a layered waterfall format that lists and indents the lower levels below the higher levels listed in the pane. Once the user has accessed the information stored at the patient level and then the procedure level of the imaging presentation, the user can access all of the available image, audio, video, patient, and report data in the imaging presentation.

In a preferred embodiment, the first page of the imaging presentation is a “start page” in which the information is organized by patient, procedure, and/or file type to allow for the easy retrieval of information. For example, over the course of several days, ultrasound equipment may record and store information related to multiple patients, who may have had multiple procedures or been involved in multiple studies, each of which likely has multiple associated images. The start page may display the top level of the hierarchical organization, which could include information relating to one or more patients and one or more imaging modality procedures. The start page may list the contents of the imaging presentation, such as a list of patients, date and time information, and the name of the institution where the ultrasound procedure was performed. A preferred embodiment of the invention has a customized start page based upon the extent of information included in the imaging presentation and the intended user of the information. For example, the start page of a imaging presentation intended for a patient would likely include the name of the institution, the name and contact information of the performing physician, the name and contact information of the referring physician, and a course of treatment based upon the physician's diagnosis.

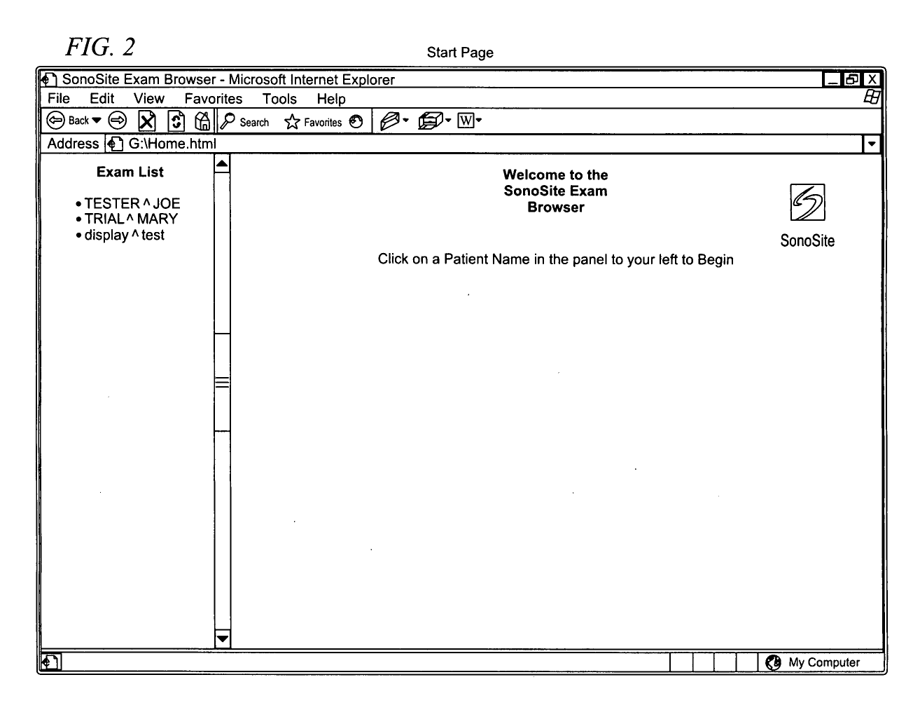

FIG. 2 illustratively represents the screen display of an exemplary presentation frame of a start page provided by the hierarchical organization of data output according to an embodiment of the invention, which shows an exam list with three hyperlink entries on the left pane of a web browser screen that represent individual patients in this example. Once the user selects a particular patient by selecting the appropriate hyperlink, the imaging presentation will display another screen that will provide information on the patient represented by the hyperlink. When compared to the lack of familiarity involved with the use of individual proprietary software applications, all of the content can be accessed and the system traversed in a manner that is familiar to anyone who has used the Internet.

The design of the imaging presentation may allow the user to obtain basic information about a patient or procedure without having to access a complete diagnostic image or scroll through various imaging reports to find the needed information. For example, if a user were interested in pulling up the images for an imaging procedure that took place on a particular day, the user would not be required to review individual reports because the date and time each procedure was performed can be listed as part of the display. These types of information may be sprinkled throughout the imaging presentation so that the user has efficient means for locating and retrieving particular information without having to review entire data files to locate the desired information.

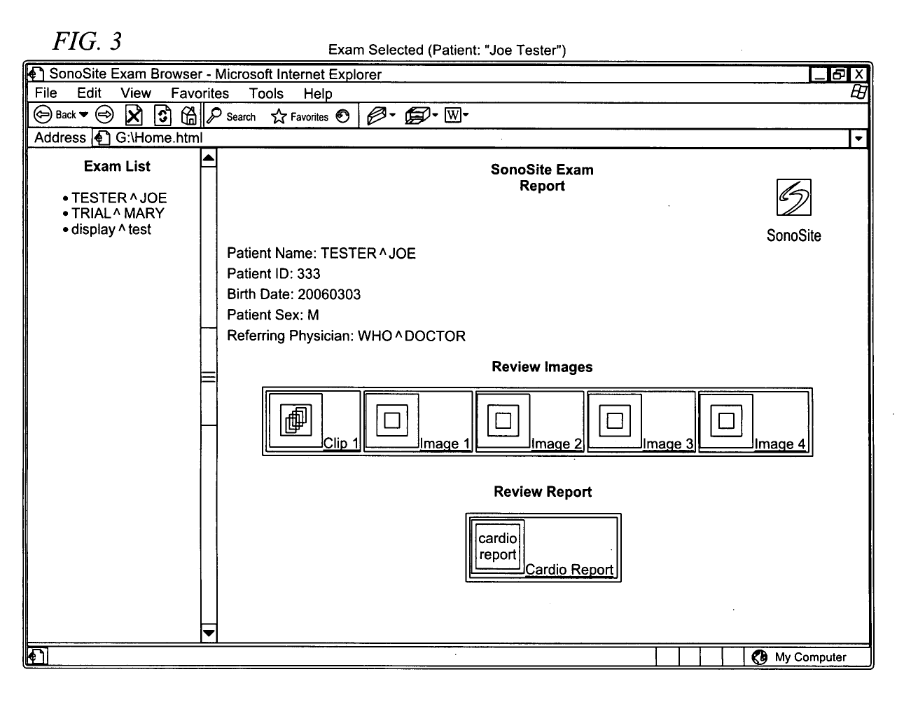

FIG. 3 illustratively represents the screen display of an exemplary presentation frame of an exam report page for patient “Tester, Joe” as may be accessed from the start page of FIG. 2, which includes information relating to the patient and which gives the user the option of reviewing video clips, images, or a report relating to the ultrasound procedure performed. Ultrasound images can be accessed by double-clicking on one of the hyperlinks, which will open up an window containing the requested image.

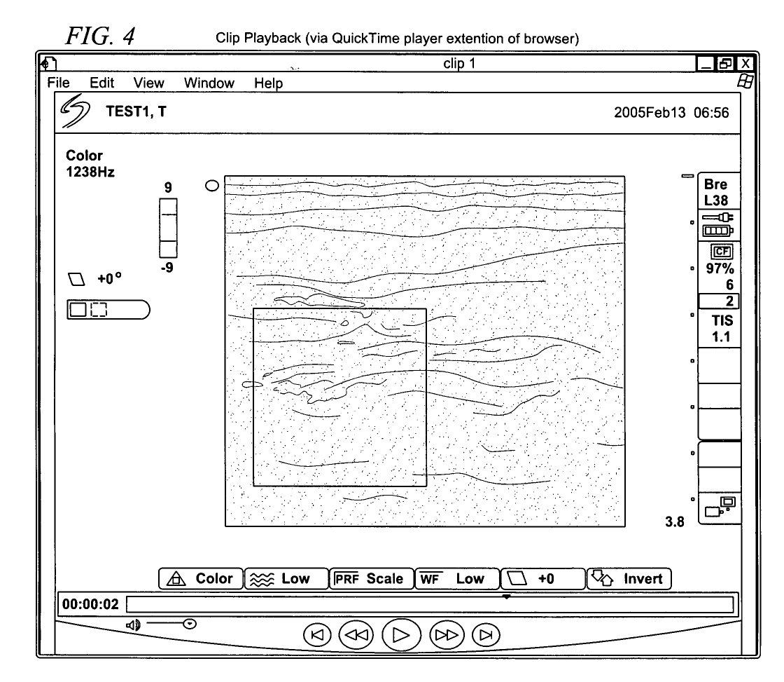

FIG. 4 illustratively represents the screen display of an exemplary presentation frame of an ultrasound video clip, which is being accessed via QuickTime®, which can be incorporated into a platform-independent interface. Such a screen display could be accessed from a screen display of an exam report page, such as the one shown in FIG. 3.

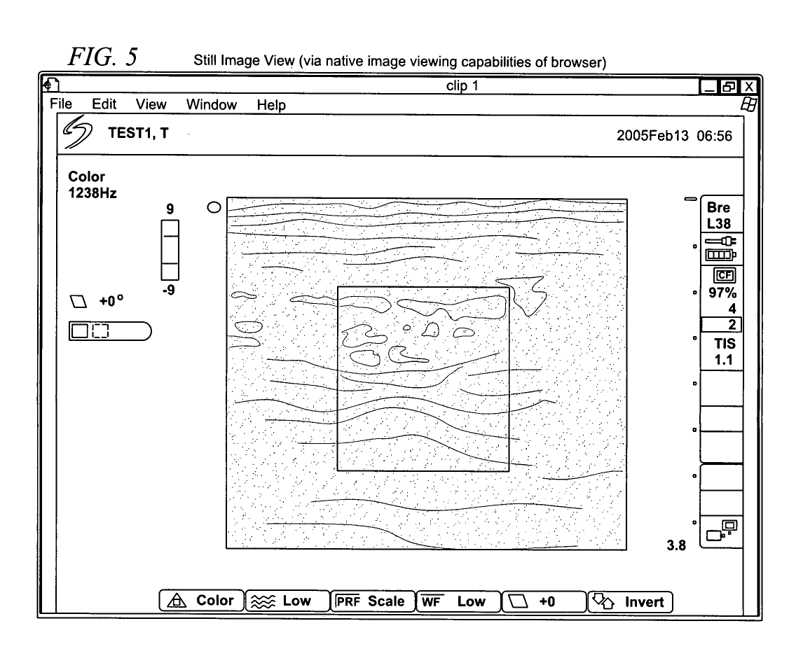

FIG. 5 illustratively represents the screen display of an exemplary presentation frame of an ultrasound still image, which can be accessed via the native image viewing capabilities of a platform-independent interface. Such a screen display could be accessed from a screen display of an exam report page, such as the one shown in FIG. 3.

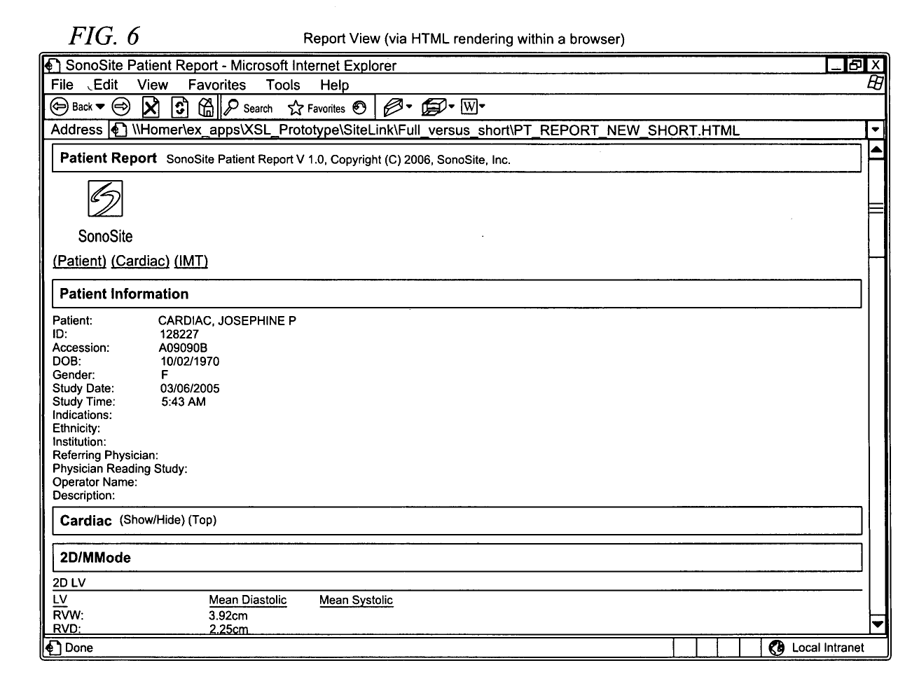

FIG. 6 illustratively represents the screen display of an exemplary presentation frame of a patient's cardiac report, which can be accessed via HTML rendering within a platform-independent interface. Such a screen display could be accessed from a screen display of an exam report page, such as the one shown in FIG. 3.

Although FIG. 1 shows an embodiment of the invention in which the imaging modality unit collects the raw data, formats the raw data, organizes the formatted data into the hierarchical arrangement, creates the imaging presentation, and records the presentation onto portable media, many of these processes can be performed by a personal computer or computer network that is external to the imaging device. In alternative embodiments of the invention, one or more of these processes is performed by a personal computer or computer network after the raw diagnostic data is collected from the imaging device. In other embodiments of the invention, personal computers may receive the raw diagnostic data directly from the imaging device and receive patient and report raw data from that equipment or other sources and perform the remaining processes of the claimed invention. These embodiments of the present invention improve on the prior art even when the functions are performed by a personal computer or computer network because of the comprehensive, intuitively-formatted solution that is provided to the user via the conversion of raw data, the hierarchical arrangement in storing the data, and the generation of the comprehensive imaging presentation that can be exported onto portable media and accessed using a platform-independent interface.

The portable media of embodiments contains the imaging presentation that allows the user to access the presentation much like a web page that has been accessed over the Internet. The platform-independent structure is designed to effectively display the imaging presentation using an inherently intuitive system that requires no special programming or software to access. Once the user receives the portable media, the user can then load the portable media onto his personal computer, which allows the user to navigate through the hierarchical arrangement to locate and view information relating to one or more imaging procedures. An alternative embodiment of the present invention would allow the user to access the imaging presentation by directing the web browser of the user's personal computer to a remote web server where the portable media is located.

Information flow of medical information across the Internet may employ encryption techniques to restrict access of the presentation to authorized users. Encryption and decryption software and/or hardware that utilize 128-bit encryption (current standard) are commercially available and can be easily implemented to allow the user to obtain authorization and/or an access code, which enables the user to view the imaging presentation. Encryption can be integrated into the process whether the user is accessing the presentation over the internet or accessing the presentation directly using the portable media. Once the imaging presentation is accessed using the portable media, the relevant content can be easily retrieved, viewed, printed, archived, or transmitted.

The imaging presentation can be accessed using a platform-independent interface because all of the data is formatted so that no proprietary or non-standard software is needed to view the presentation contained on the portable media. One embodiment of a platform-independent interface that natively supports a variety of standard formats is a standard web browser and any plug-ins that allow the user to view computer files that are written in non-proprietary or open source formats. This embodiment of the invention can be used in any sort of computing environment equipped with a standard web browser and standard plug-ins, regardless of the computing platform (e.g., PC, Macintosh, Unix). In this way, the distribution and redistribution of custom software is avoided by leveraging widely available web technology to allow for the traversal and rendering of diagnostic information on a variety of different platforms.

One embodiment of the invention issues portable media containing directives to auto-launch the resident web browser on the personal computer whenever the relevant media is recognized by the computer. This auto-launch feature initiates the presentation of the content contained on the portable media.

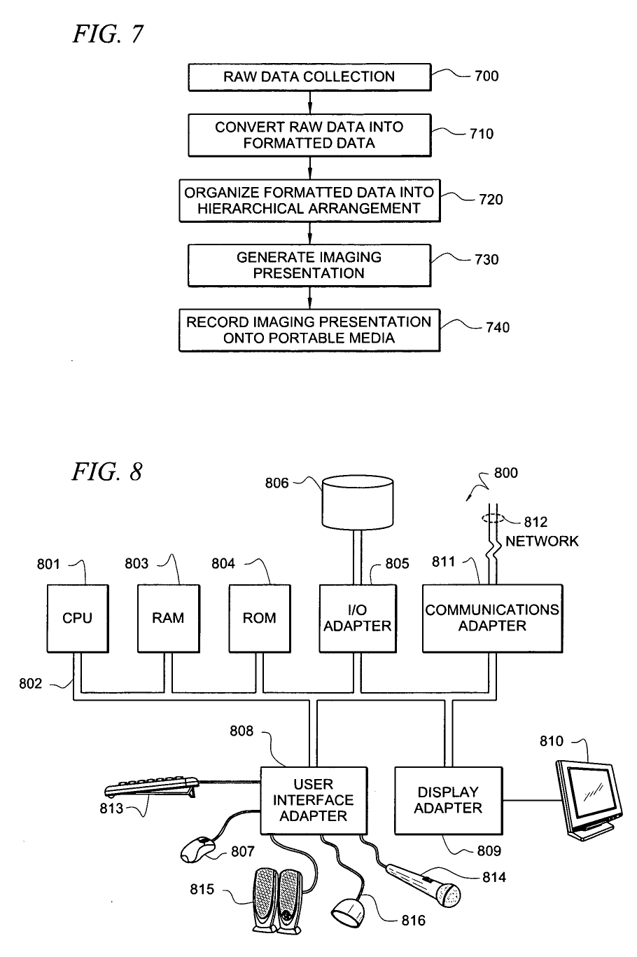

FIG. 7 is a flow chart demonstrating a method of converting the raw data from an imaging device into a usable format that is recorded onto portable media in accordance with an embodiment of the present invention. Process 700 captures the raw data in its various forms from sources that are either internal or external from an imaging device. Process 710 then converts this raw data into formatted data that utilizes standard formats. Process 720 then organizes the formatted data, which may include JPEG, MPEG, WAV, XML, HTML, or XHTML files, into a hierarchical arrangement that allows for easy location and retrieval of the formatted data.

Process 730 generates an imaging presentation to enable a user of the portable media to view the content the imaging presentation. Process 740 records the imaging presentation onto portable media. Therefore, if the portable media is a compact disc, the imaging modality unit or the personal computer performing the recording function would write the final content to the compact disc using any one of a number of commercially available software and/or hardware solutions. After the recording/saving process has concluded, the portable media can be preserved for subsequent use, copied, or otherwise sent or made available to the eventual user of the portable media. The method claimed by this invention can be performed, in whole or in part, by computer software that may be created using a variety of commercially available developmental tools, such as C++ or Java, to create the proper code necessary to perform the claimed method.

When implemented via computer-executable instructions, various elements of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

FIG. 8 illustrates a processor-based imaging system 800 adapted according to embodiments of the present invention. That is, imaging system 800 comprises an example system on which embodiments of the present invention may be implemented. Central processing unit (CPU) 801 is coupled to system bus 802. CPU 801 may be any general purpose CPU. However, the present invention is not restricted by the architecture of CPU 801 as long as CPU 801 supports the inventive operations as described herein. CPU 801 may execute the various logical instructions according to embodiments of the present invention. For example, CPU 801 may execute machine-level instructions according to the exemplary operational flows described above in conjunction with FIG. 2.

Imaging system 800 preferably includes random access memory (RAM) 803, which may be SRAM, DRAM, SDRAM, or the like. Imaging system 800 preferably also includes read-only memory (ROM) 804 which may be PROM, EPROM, EEPROM, or the like. RAM 803 and ROM 804 hold user and system data and programs, as is well known in the art. Imaging system 800 preferably also includes input/output (I/O) adapter 805, communications adapter 811, user interface adapter 808, and display adapter 809. I/O adapter 805, user interface adapter 808, and/or communications adapter 811 may, in certain embodiments, enable a user to interact with imaging system 800 in order to input information, such as patient or report data.

I/O adapter 805 preferably connects to storage device(s) 806, such as one or more of hard drive, compact disc (CD) drive, floppy disk drive, tape drive, etc. to imaging system 800. The storage devices may be utilized when RAM 803 is insufficient for the memory requirements associated with storing the necessary data. Communications adapter 811 is preferably adapted to couple imaging system 800 to a computer network 812. User interface adapter 808 couples user input devices, such as transducer probe 816, keyboard 813, pointing device 807, and microphone 814 and/or output devices, such as speaker(s) 815 to imaging system 800. Display adapter 809 is driven by CPU 801 to control the display on display device 810 to, for example, display the imaging presentation prior to its being recorded/saved on the portable media.

It shall be appreciated that the present invention is not limited to the architecture of imaging system 800. For example, any suitable processor-based device may be utilized, including, without limitation, imaging devices, imaging modality units, personal computers, laptop computers, handheld computing devices, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention, including structures incorporated into imaging devices or computer systems.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for organizing dissimilar data derived from one or more imaging devices to create a platform-independent imaging presentation, the method comprising:
collecting dissimilar raw data from one or more imaging devices;
converting said raw data into formatted data;
organizing said formatted data into a hierarchical arrangement adapted to facilitate a platform-independent presentation of said formatted data; and
recording said formatted data onto a portable media.

2. The method of claim 1 wherein said portable media contains an auto-launch directive to automatically initiate said imaging presentation.

3. The method of claim 1 wherein said imaging device is an imaging modality.

4. The method of claim 1 wherein said imaging device is an ultrasound unit.

5. The method of claim 1 wherein said imaging device is an X-ray unit.

6. The method of claim 1 wherein said imaging device is a computer tomography unit.

7. The method of claim 1 wherein said imaging device is a magnetic resonance imaging (MRI) unit.

8. The method of claim 1 wherein said imaging device is a nuclear medicine imaging unit.

9. The method of claim 1 wherein said raw data is data embodied in a proprietary or non-standard format.

10. The method of claim 1 wherein said formatted data is data embodied in a non-proprietary, standard, or open source format.

11. The method of claim 1 wherein said dissimilar data is data embodied in different formats due to the nature of the data (i.e., text, audio, image, video).

12. The method of claim 1 wherein said platform-independent presentation is a presentation formatted so that no proprietary or non-standard software is needed to view the presentation.

13. The method of claim 1 wherein said platform-independent presentation is a presentation that can be viewed using a standard web browser and any plug-ins that allow the user to view computer files that are embodied in a non-proprietary, standard, or open source format.

14. The method of claim 1 further comprising loading the portable media onto a personal computer.

15. The method of claim 1 further comprising accessing said imaging presentation from the portable media using a platform-independent interface.

16. The method of claim 1 further comprising loading the portable media onto a web server.

17. The method of claim 16 further comprising accessing said imaging presentation on a personal computer by accessing said web server over the Internet.

18. A system for organizing dissimilar data derived from one or more imaging devices to create a platform-independent imaging presentation, the system comprising:
one or more imaging devices for collecting raw data;
one or more format converters that convert said raw data into one or more standard formats;
a hierarchical organizer that that organizes said formatted data into a hierarchical arrangement;
an imaging presentation generator that generates a platform-independent imaging presentation; and
a media recording device storing said platform-independent imaging presentation for access by a presentation system other than said one or more imaging devices.

19. The system of claim 18 wherein said imaging device is an imaging modality.

20. The system of claim 18 wherein said imaging device is an ultrasound unit.

21. The system of claim 18 wherein said imaging device is an X-ray unit.

22. The system of claim 18 wherein said imaging device is a computer tomography (CT) unit.

23. The system of claim 18 wherein said imaging device is a magnetic resonance imaging (MRI) unit.

24. The system of claim 18 wherein said imagine device is a nuclear medicine imaging unit.

25. The system of claim 18 further comprising said portable media.

26. The system of claim 18 further comprising a web server with access to said portable media for accessing said imaging presentation over the Internet.

27. The system of claim 18 further comprising a means for encrypting and decrypting said imaging presentation.

28. The system of claim 18 further comprising a personal computer with access to said portable media.

29. A system for organizing dissimilar data derived from one or more imaging devices to create a platform-independent imaging presentation, the system comprising:
means for collecting dissimilar raw data from one or more imaging devices;
means for converting said raw data into formatted data;
means for organizing said formatted data into a hierarchical arrangement;
means for generating a platform-independent imaging presentation; and
means for recording said imaging presentation onto a portable media.

30. The system of claim 29 further comprising a means for encrypting and decrypting said imaging presentation.

31. An article of manufacture comprising:
a computer usable medium having computer readable program code means embodied therein for organizing dissimilar data derived from one or more imaging devices to create a platform-independent imaging presentation, the computer readable program means in said article of manufacture comprising:
computer readable program code means for causing a processor to convert said raw data into formatted data; and
computer readable program code means for causing a processor to organize said formatted data into a hierarchical arrangement adapted to facilitate a platform-independent presentation of said formatted data.

32. The article of manufacture of claim 31 further comprising computer readable program code means for causing a processor to encrypt said imaging presentation.

33. The article of manufacture of claim 32 further comprising computer readable program code means for causing a processor to decrypt said imaging presentation.

34. The article of manufacture of claim 31 further comprising computer readable program code for causing a processor to store said imaging presentation on a web server.

35. The article of manufacture of claim 31 further comprising computer readable program code for causing a processor to store the imaging presentation onto portable media.
